(19) United States
(12) Patent Application Publication
(10) Pub. No.: US 2019/0279142 A1
(43) Pub. Date: Sep. 12, 2019

(54) VinVerifEye

(71) Applicant: Susan Andrews, Longwood, FL (US)

(72) Inventor: Susan Andrews, Longwood, FL (US)

(21) Appl. No.: 15/915,214

(22) Filed: Mar. 8, 2018

(51) Int. Cl. G06Q 10/08; G06Q 40/02

(52) U.S. Cl. CPC G06Q 10/087; G06K 19/0723; G06Q 40/025

(57) ABSTRACT

This disclosure relates to a method of inspecting a physical asset(s) using a mobile computing device is disclosed. Data regarding the asset the location of the asset is collected on the mobile device by a user and may include dual camera photographs, audio or picture in picture video recordings, text or other types of data. The data is automatically date and time stamped and the GPS coordinate of each asset that is located from the device with the RFID adhered to the asset. The data is transmitted to a server and saved in a manner such that it may not be modified. This allows for auditing, as well as tracking of the asset over time by comparing data entered at one time with data entered at another time with measurements created from RFID with an automated instrument such as a ruler to obtain the width and height of the placement of the RFID and Vehicle Identification Number(VIN) outside of the perimeter and the difference in between measurement to initiate a unique measurement between the vin and RFID placement. Reports are generated from an aggregated source or manually entered into the software. The reference would be compared based on the unique identifier such as the Vehicle Identification Number(VIN) of the asset or other unique identifiers that are created at the time of registering the asset.

### BACKGROUND

### Field of the Invention

The present invention relates to a software that can be used online and through devices with IOS or Android features for disclosure relates to a method of inspecting a physical asset(s) using a mobile computing device is disclosed.

### SUMMARY

### Background of Invention

The present invention relates to a method and system for monitoring the status of individual items of personal property which serve as collateral for securing financing and, more particularly, to a method and monitoring system for receiving financing information from a plurality of financing sources and for authenticating the financing information received from the different financing sources to determine whether a particular item of personal property simultaneously serves as collateral to secure financing from more than one financing source.

In many inventory related industries, retail dealers, such as vehicle or boat retailers, obtain floor plan credit lines from an inventory financing source, such as a bank or captive finance company (i.e., GMAC, Ford credit, Chrysler credit) for the purchase of the vehicle or boat inventory. The floor plan credit line is a loan granted by the financing source to the retailer which acts as a revolving credit line for purchasing inventory stock, e.g., a plurality of vehicles by a vehicle dealership. As the inventory is sold, new inventory stock is received by the retailer. Therefore, the financing source has a specific security interest in each item of inventory, but cannot perfect its interest using customary procedures, such as individual UCC filings for each item of inventory.

Therefore, the loan may be collateralized with a blanket lien with additional cross- collateralization. Typically, the floor plan loan is to be repaid at least in part within a predetermined short predetermined period of time (i.e., 3-5 days) after a particular inventory item is sold, regardless of whether the retail customer pays in full or finances the purchase. Normally, the financing source monitors the status of the floor plan credit line by making periodic visits to the retailer and manually checking for the presence of the particular inventory items.

The inventory items are typically identified by a serial number associated with the particular item. Manual confirmation of the credit status of the inventory items is time-consuming and because it is not done often, is normally not up to date. Some retailers take advantage of the delay in ascertaining the correct status of the collateral items by not immediately repaying the loan once an inventory item is sold; using the money as a “float” for financial gain. In some situations, the retailer may be financially unstable and may eventually be unable to repay the floor plan credit line.

Since the collateral has been sold in the ordinary course of business, the floor plan financing source whose loan is no longer secured by collateral in possession of the dealer, has no recourse against the consumer who purchased the item. In effect, the collateral has been relinquished by the floor plan financing source to the consumer financing source, which can repossess the item in the event that the consumer defaults on his/her loan obligation. Additionally, if the retailer files for bankruptcy, the financing source which financed the floor plan credit line becomes an unsecured creditor and may not have much of a chance of having its debt repaid.

The financing sources also typically monitor the status of consumer instalment loans to prevent consumers from taking advantage by not repaying their loans. In some situations, the consumer may try to take advantage of the financing source by engaging in multiple loan contracts, such that each loan contract is with a different financial lender. In the event of default of one or more of the loans by the consumer, it is later discovered that the lenders are sharing the collateral which is inadequate to cover all the loans.

Additionally, sometimes consumers finance the purchase of new personal property by trading in old personal property such as in the purchase of a new vehicle. If the consumer has an outstanding loan for the old personal property which is not subsequently repaid the financing source has no recourse to recover the balance of the loan.

There is a need for a system which can monitor the status of a floor plan credit line and the credit status of a particular inventory item on a more frequent basis, preferably at least daily. The present invention is directed to a method and system for monitoring the status of individual items of personal property which serve as collateral for securing financing which generally receives input preferably on a daily basis from a plurality of subscribers. The subscribers are typically financing sources which provide floor plan credit lines and financing sources which provide any type of consumer credit, such as, but not limited to, loans, leasing, lease-line financing and credit union loans for the ultimate purchase of the collateral items.

The data is organized by the serial number or some other unique identification code of each inventory item and any subsequent loan entry is associated therewith. If the monitoring system determines that two credit loans simultaneously exist for a particular inventory item, at least one respective financing source is notified so that appropriate action can be promptly taken. In this manner, the inventory financing source can learn at the earliest known point in time when a subsequent consumer loan has been granted so that it can make sure its loans are promptly repaid.

### SUMMARY OF THE INVENTION

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

According to a first embodiment the present invention is Retail floor planning (also referred to as “Floor plan” or inventory financing) is a type of short-term loan used by retailers to purchase high-cost inventory such as automobiles. These loans are often secured by the inventory purchased as collateral. Floor planning is commonly used in new and used car dealerships.

Embodiments of the invention relates to simplify and establish ease of use for the dealership with a 3rd party automated inspection service. Streamline units in question in one document rather than multiple calls or emails to the same location. In turn, will mitigate losses for the floor plan provider and cut down on time and costs for everyone involved. Often times, dealers may sell a vehicle and not pay the floor plan provider within their guidelines. The object is to identify where the floor planned units are located either at random or at all times predicated on the RFID technology and floor plan providers guideline that utilizes this product.

At this time, Floor Plan audits are operated by a 3rd party inspection company hire field auditors that do not possess full knowledge of the floor plan business. This technology will create the consistency of policy and procedure with ease of use. Often times the Floor plan Auditor would need to ask the dealer to either walk the dealership or interrogate where units are located provided on the inventory list. The dealership has multiple roles and responsibilities which creates a level of frustration when the auditor arrives with different expectations.

Instead of having the auditor taking the time from the dealer, in turn, will increase efficiencies and streamline this event while providing a heightened automated inspection service with logic and consistency with policy and procedure regarding inventory management.

There have been instances when an auditor or employee of a floor plan company has been either bribed and/or taken money or gifts from dealerships to “verify” the unit without knowledge of their employer or finance company. This also includes providing in advance notice of the audit dates which defeats its purpose of having audits.

Personal Example: Dealer was audited by 3rd party inspection service, GM was prepared with supporting documentation of a unit sold 3 months prior. As soon as the audit was completed by 3rd party inspection service, the unit that was sold 3 months prior was “visually verified” by the 3rd party inspection service. The GM sent the representative of the Floor plan company within 6 hours of the audit to find 24 units missing. It was admitted in a meeting by the Dealer that the units were not on the lot at the time of inspection.

Although I've not had first had experience with fraudulent activity by employees of the current floor plan provider, it is common knowledge this conduct has happened by either management or employee of the floor plan company.

This software application will keep both sides honest and provide investors with the comfort and knowledge the system cannot be deviated due to personal relationships.

With the use of RFID technology. The ideal situation is for a waterproof destructible NFC RFID Windshield tag be affixed above the Vehicle Identification Number(VIN) plate on the windshield or affixed next to the Vehicle Identification Number(VIN) inside the door for any unit that is floor planned.

The dealer should have the ability to link or aggregate their dealer floor plan data into VinVerifeye's portal or website in order to have a list of current units on their floor plan.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 shows units for audit.

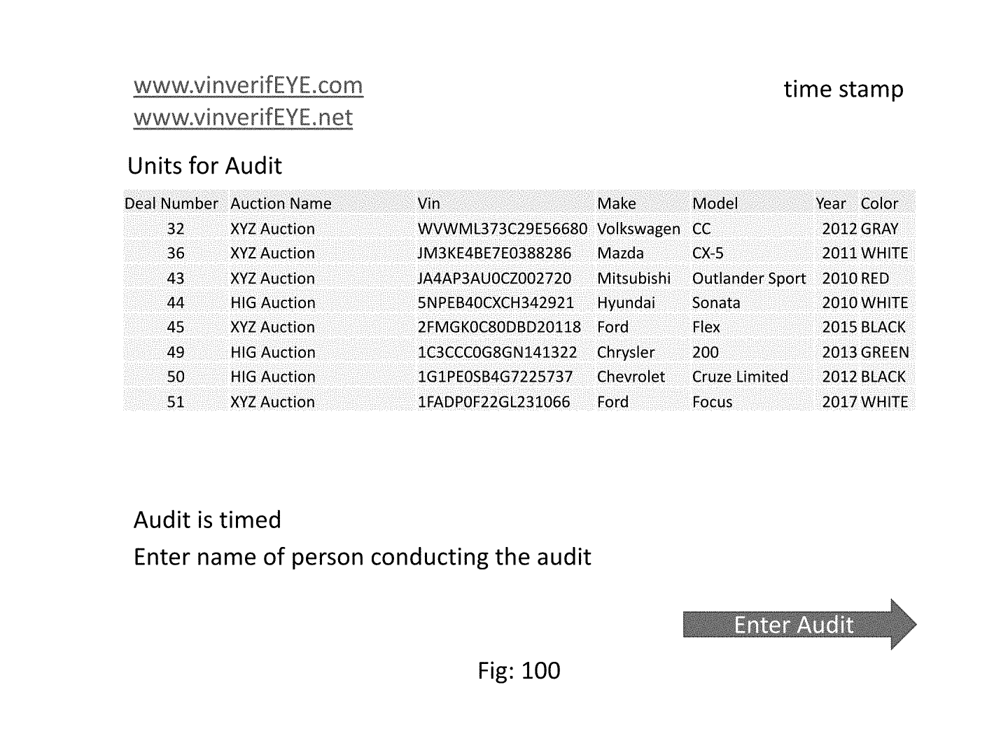

FIG. 200 shows dealership report.

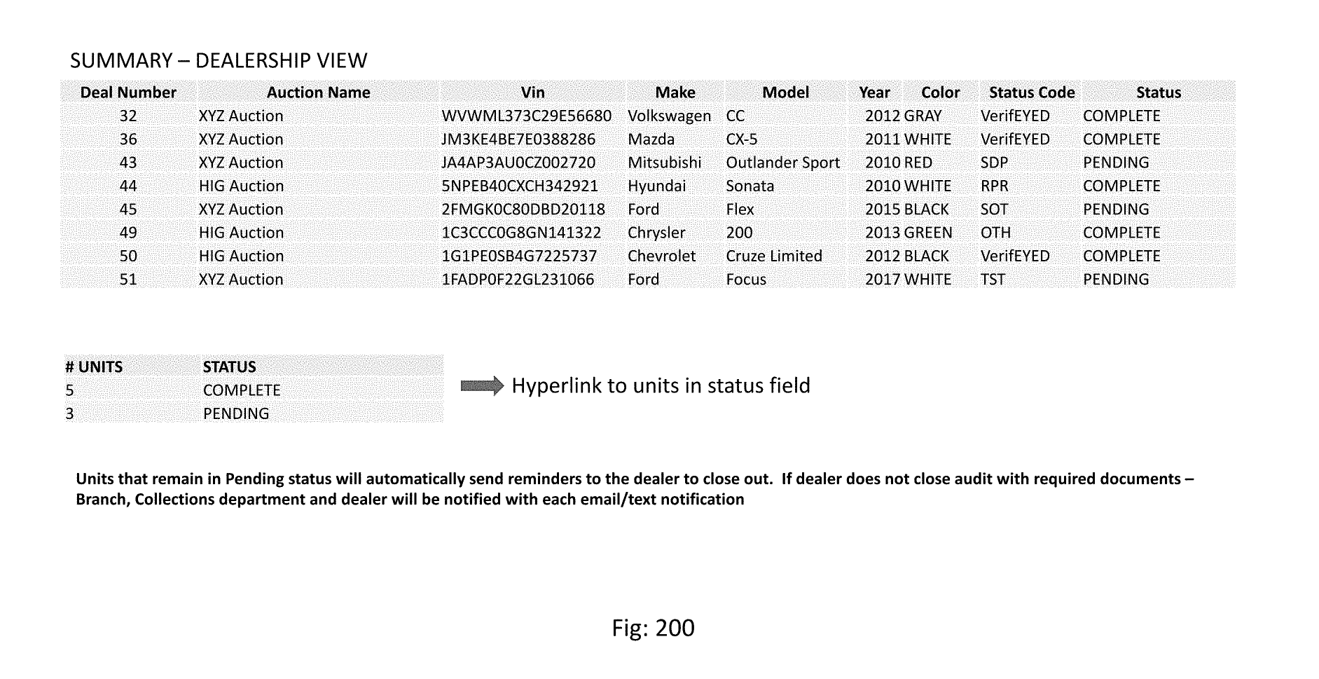

FIG. 300 shows floor plan view.

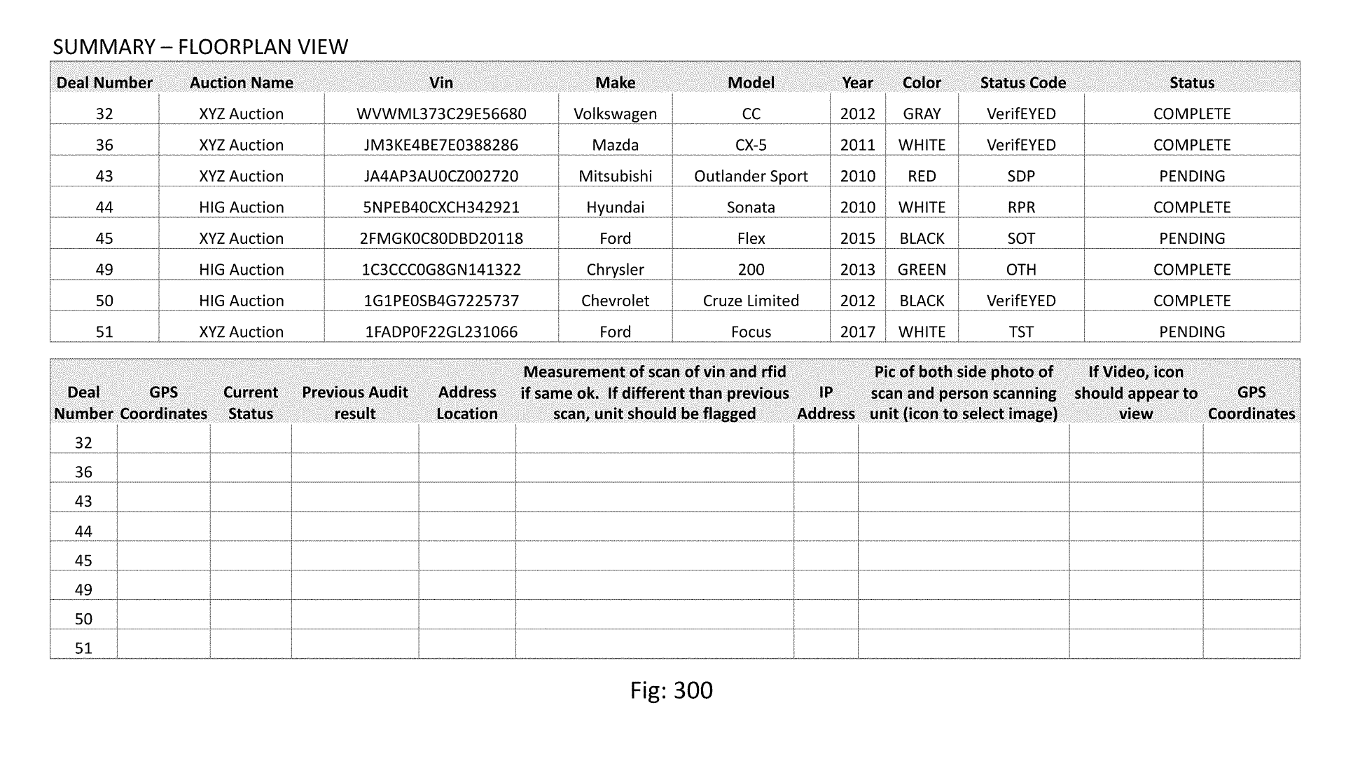

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before explaining the invention in detail, it is to be understood that the invention is not limited in its application to the detail of application illustrated in the drawings since the invention is capable of other embodiments and of being practised or carried out in various ways. It is also to be understood that the phraseology or terminology employed is for the purpose of description only and not of limitation.

The present invention corresponds to the RFID to the unit on the floor plan inventory the following should occur:
all the units are uploaded by the floor plan company—VinverifEYE should have the ability to aggregate their information into this software and create a unique identifier for VinVerifEYE in order for the dealer to simply select the Vehicle Identification Number(VIN) number and take photos. Many times, dealerships have multiple floor plan providers hence multiple inspectors meeting with the dealer minimum twice a month. This service will help in all aspects for all entities involved.
Ideally, the dealer should be able to log in and see all units floored. The dealer can either scan units with RFID to immediately VIN VerifEye units or enter the last six of the Vehicle Identification Number(VIN) to auto-populate the unit to reconcile.
The dealer should have 3 separate buckets when initializing units from floorplan. The 2nd bucket has different tiers to verify
1—to place RFID sticker on the newly floored unit (after completing stage 1, it should automatically fall in category 3) and bypass the second category as long as GPS coordinate and mobile number that is verifying the unit.
2—Units to be verified
Sold not funded—retail finance awaiting payment from bank
Sold funded (cash, buy here pay here or retail financed and has been already funded)
Repair or Mechanic shop
Other
At Auction
At dealership
Test Drive
In-Transit
3—VinVerifiEyed-Complete
As each unit has been inspected, it will automatically be placed in the “completed” or “Vin VerifEyed” bucket which will allow the dealer to visually identify the remaining units to be inspected.
Dealer is to place the RFID sticker above or next to the yin plate on the windshield or inside door. Once it has been adhered to the windshield or door, the dealer should have the option for the Vehicle Identification Number(VIN) number to auto-populate, enter the last six of the Vehicle Identification Number(VIN), or select the Vehicle Identification Number(VIN) from the inventory list in application and take picture of the Vehicle Identification Number(VIN)and RFID together,
the dealer should also have the ability to take up to 10 pictures per unit or video for up to 30 seconds to provide a thorough visual inspection, predicated on what the requirements are for the floor plan company—my vision when scanning the Vehicle Identification Number(VIN) and RFID is to make it look like what a bank has when depositing checks online but show the entire picture not just what is within the perimeters. The front will be the RFID and the bottom would be the yin which is located below the RFID.
The app should be able to read the Vehicle Identification Number(VIN) number and associate the unit to the RFID that's been assigned. Once both the vin and RFID create an association, it will become the yin as the unique identifier with an additional code in case the waterproof destructible RFID has been altered in any way. This RFID cannot be modified whatsoever. If the yin in the windshield cannot read, the last six can be entered and select the unit on the floor or select from the inventory list.
The GPS coordinates for each pic should be provided to the floor plan provider. This will verify where the vehicle is actually located.
The distance between Vehicle Identification Number(VIN) and RFID should be measured/calculated and provided—this item should be flagged as fraud if the dealer's coordinates between to two pics are not a match. Example: 2 centimetres difference from previous picture form the current picture will be flagged. (The object is to not have the dealer fraudulently scan the Vehicle Identification Number(VIN) of another unit or try to place RFID in another location—the pic will have object identification overlay to match the exact position between the Vehicle Identification Number(VIN) and RFID.
the time it takes to scan the Vehicle Identification Number(VIN) to the RFID
a picture should use both sides of the camera simultaneously. Each photo taken will show the person taking the picture as units are registered with Vehicle Identification Number(VIN) and or RFID. This will mitigate risk by showing the simultaneous photo's from both sides of the camera with RFID
GPS coordinates that are time-stamped and signed by the dealer at the end of each session. In turn can work proactively vs. reactively if fraudulent activity occurs.

Random requests for audits will be sent to dealer based on the criteria of allowable dates that have been preselected from their floor plan provider. It should be tracked to each device that updates data...i.e. dealer/mechanic/auction with IP address and GPS coordinates. It should also Ping the last location. The app should be uploaded on all devices to locate unit based on RFID technology. When the request has been sent, the audit must be completed within a set time
perimeter selected by the floor plan company. If the audit is not complete in a selected timeframe, can result in additional fee's the dealer can be imposed by the floor plan company for non-compliance.

When the audit occurs, the dealer would have the following scenario's when an inspection occurs:
Sold not funded—retail finance awaiting payment from bank
Sold funded (cash, wholesale, buy here pay here or retail financed)
Repair or Mechanic shop
Other
At Auction
At dealership
Test Drive
In Transit
The following should occur for each of these categories:
Sold not funded—Funding notice must be uploaded into software- this must be an unaltered authentic document, it must be time-stamped—unfortunately, there are times when a dealer would modify a document before providing the information to the floor plan company as proof of pending status.
Sold funded (cash, buy here pay here, wholesale or retail financed and has been already funded)—Sales Contract should be uploaded—payment is due immediately—Item must be flagged, account automatically locked—Branch or Corp office should be notified by end of busness with list of units that fall within category
Repair or Mechanic shop—the dealer should have the ability to text this Vehicle Identification Number(VIN) to the mechanic ,repair shop or other to scan the RFID tracking into the system. Once it has been scanned and a person from a location can click send, it goes back to the specific unit of the dealer conducting the audit as being complete. Again, whenever a unit has been scanned or picture taken, this goes on both sides of the camera and a GPS coordinate should also be recorded along with mobile number. Name of Repair or Mechanic shop should match GPS coordinate. The telephone number of text of where and when the Vehicle Identification Number(VIN) has been sent should also be documented with a signature from repair or mechanic shop
Other location—same as repair shop—dealer should have the ability to update notes in the system and photo/scan should be uploaded with GPS coordinates and mobile number—must match address to GPS coordinate
At Auction—same as repair shop or dealer must provide information of which auction location—floor plan provider to call auction to verify unless dealer goes to auction and provides information through the app, if item not Verified, unit(s) will be sent in a consolidated format to the corresponding auction in one file to decrease their time spent on verifying the units at auction.
At dealership—scan/pictures taken
Test Drive—document of driver's license and corresponding documents should be uploaded to the system of the person test driving the unit. If the unit has not been assigned an RFID the unit should still have pictures taken but will still be considered unverified until RFID has been assigned to the unit.

Now that the RFID has been scanned initially, the dealer will not have to do this for each audit. This only applies to new units on the floorplan. If an audit occurs again and the same unit is on the floor, all they need to do is scan the RFID. Again a pictures of both sides of the camera should occur simultaneously and provide GPS coordinates with mobile number assigned to audit.

The information documented from the previous audits should also be provided to the floorplan provider on the backend when reviewing dealers inspection results, including previous GPS coordinates, mobile number, # days on the floor. The unique identifier aka Vehicle Identification Number(VIN) should be followed throughout the entire loan process until the unit has been paid in full. If the unit is refloored by the same dealer—the previous audit information should also be provided as knowledge to help with risk mitigation. Including the object recognition overlay of Vehicle Identification Number(VIN) and destructible RFID and GPS with coordinate to decipher the differences from the previous audit (unique identifier is same)
Tags can be ordered through the app. A monthly service fee to be charged to the dealer as well as each unit that has been scanned in the system per unit.

RFID tag should be able to release data to another floor plan with supporting information. Again, this is an option to provide the previous audit information to the subsequent floor plan company. Predicated on Master Inter-Creditor agreements and dealer authorization as long as it is the same dealer.
Vehicle Identification Number(VIN) scan
RFID scan
Photo/video both sides
GPS coordinates
Valuation tool added to both dealer and floor plan company

2nd Criteria of this software is what dealers refer to as Outside Buys “OSB” or non-auction purchase “NAP”. The majority of the units purchased by dealers are through Auto Auctions. When this does not occur and the dealer wants to floor plan this unit it will be considered an “OSB” or “NAP”

Same criteria as before but the dealer must put in the full 17 digits of the Vehicle Identification Number(VIN) or scan the Vehicle Identification Number(VIN) from the door of the vehicle. The application software should have Vehicle Identification Number(VIN) decoder in the application so the year makes model will automatically be uploaded with any data that has not been uploaded must be completed by the dealer.

Once the RFID scanner has been affixed to the Vehicle Identification Number(VIN) plate on the windshield or door, the same will apply to the above. The dealer should also provide a copy of the title front and back, bill of sale and supporting documentation up to 10 pictures and/or upto 30 seconds of videos of the unit. The dealer should have the ability to email the request to the floorplan company of their choice from the application or software and it will be up to the floorplan company to accept this as proof of unit or place a contingency based on the arrival of documentation. We will need to access contact list in order for the contact info to populate
When the request has been sent into the floor plan to fund it should have all the data as if it were a lot audit.

This unit will also give the ability to floor outside buys with providing RFID attached to the unit with extra photos of video of unit and copy of Bill of sale and proper reassignment of the title. Once the price has been agreed upon the system will accept and funded based on floorplan company guideline.

Dealer will select which floor plan and send a request directly to the company. An approval or decline will be sent to the floor plan company and should decide within 24 hours. If accepts, it will automatically floor the unit in the system and it will be at the floor plans discretion to pay unit based on their guidelines. As confirmation, the email will also be cc'd to the dealer.

At the end of each session, the dealer will sign the document after he/she accepts that any fraudulent information sent through the internet is considered a federal offence and provide the ramifications and years of imprisonment or fines that will be involved in such fraudulent activity if found guilty. GPS location will also be provided.

3rd Criteria of this software is what dealers refer to as Flooring Trades with Bank balance
The majority of the units purchased by dealers are through Auto Auctions. When this does not occur and the dealer wants to floor plan this unit it will be considered an “OSB” or “NAP”
Same criteria as before but the dealer must put in the full 17 digits of the Vehicle Identification Number(VIN) or scan the Vehicle Identification Number(VIN) from the door of the vehicle. The application software should have something like Vehicle Identification Number(VIN) decoder in the application to provide the year make model will automatically be uploaded any data that has not been uploaded must be completed by the dealer.
Once the RFID scanner has been affixed above the Vehicle Identification Number(VIN) plate on the windshield, the same will apply to the above. The dealer should also provide a copy of bill of sale
up to 10 pics of the unit
Power of Attorney
10 Day Payoff Letter from bank

The dealer should have the ability to email the request to the floor plan company of their choice and it will be up to the floor plan company to accept this as proof of unit.
It will have an accept or decline button, if accepted, the information from the bank will be notified via email and automatically floor the unit based on the payoff amount. The instructions to the bank with ACH information will be provided the prior business day with notification.
When the request has been sent into the floor plan to fund it should have all the data as if it were a lot audit.
The dealer will select which floor plan they are requesting to use and send a request directly to Floor plan company. As confirmation, the email will also be cc'd to the dealer.

At the end of each session, the dealer will sign the document after he/she accepts that any fraudulent information sent through the internet is considered a federal offense and provide the potential number of years of imprisonment or fines that will be involved if found guilty. GPS location will also be provided. If the fraudulent activity does occur, the dealer gives the audit company the right to provide a warning notice to all companies involved.

Once Dealer closes out of the audit, the summary report will be sent to both the floor plan company and Dealer for review. The data from the summary will also be aggregated into the floor plan software system for notification purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as
reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system for monitoring the status of individual items of personal property which serve as collateral for securing financing comprising:
means for receiving financing information from a financing source including a unique identification code associated with each individual item of personal property which serves as collateral for securing financing by the source;
Using software design to simplify and establish ease of use for the dealership with a 3rd party automated inspection service. Streamline units in question in one document rather than multiple calls or emails to the same location.
means for identifying a particular item of personal property which simultaneously serves as collateral to secure financing from financing sources; and means for notifying at least one of the sources about the identified item of personal property.
The system according to claim 1, wherein the means for receiving financing information from the financing source and the financing source is a computer system which includes a relational database.
The system according to claim 2, wherein the financing information from the first financing source is electronically transferred to the computer system.
The system according to claim 2, wherein the financing information from the second financing source is electronically transferred to the computer system.
The system according to claim 1, wherein the financing information from the first financing source is transmitted to the means for receiving financing information from a first financing source by a personal computer.
The system according to claim 1, wherein the financing information from the first financing source is transmitted to the means for receiving financing information from a first financing source by a main frame computer.
The system according to claim 1, wherein the financing information from the second financing source is transmitted to the means for receiving financing information from a second financing source by a personal computer.
The system according to claim 1, wherein the financing information from the second financing source is transmitted to the means for receiving financing information from a second financing source by a main frame computer.
The system according to claim 1, wherein the personal property which serves as collateral is a vehicle/Land and where the identification code comprises an identification member.
The system according to claim 1, wherein financing information is generally received from the first financing source and the second financing source on at least a daily basis.
The system according to claim 2, the data is automatically date and time stamped and the GPS coordinate of each asset that is located from the device with the RFID adhered to the asset

12. The system according to claim 1, wherein the means for notifying at least one of the first and second financing sources comprising providing a printed report.
The system according to claim 2, wherein the means for notifying at least one of the first and second financing sources comprises means for electronically transferring the financing information from the computer system to the first and second financing sources.
The system according to claim 1, wherein the financing information transmitted from the first financing source comprises information used to prepare floor plan credit loans for the purchase of inventory.
The system according to claim 1, wherein the financing information transmitted from the second financing source comprises information used to prepare consumer credit loans for the purchase of a particular item of personal property.
A system for monitoring the status of which serve as collateral for securing inventory financing of vehicles comprising:
means for receiving financing information from a plurality of first financing sources including a unique vehicle identification code associated with each individual vehicle which serves as collateral for securing dealer inventory financed by any of said first financing sources;
means for receiving financing information from a plurality of second financing sources including a unique vehicle identification code associated with each individual vehicle obtained from dealer inventory which serves as collateral for securing financing from any of said financing sources;
and means for notifying at least one of the financing sources for which an identified vehicle serves as collateral that the identified vehicle also serves as collateral for another financing source.
The system according to claim 18, wherein the means for receiving financing information from the plurality of first financing sources and the plurality of second financing sources is a computer system.
The system according to claim 19, wherein the financing information from the first financing source is electronically transferred to the computer system.
The system according to claim 19, wherein the financing information from the second financing source is electronically transferred to the computer system.
The system according to claim 18, wherein the financing information from at least one of the plurality of first financing sources is transmitted by a personal computer.
The system according to claim 18, wherein the financing information from at least one of the plurality of second financing sources is transmitted by a personal computer.
The system according to claim 18, wherein the financing information transmitted from the plurality of first financing sources comprises information used to prepare floor plan credit loans for the purchase of vehicle inventory.
The system according to claim 18, wherein the financing information from the plurality of financing sources comprises information used to prepare consumer credit loans for the purchase of vehicles.
The system according to claim 19, wherein notifying means further comprises a report which is transmitted to the affected first financing source and second financing source.
The system according to claim 26, wherein the report is electronically transferred from the computer system to the first and second financing system.
A method for monitoring the status of individual items of personal property which serve as collateral for securing financing, the method comprising the steps of receiving financing information from a first financing source including a unique identification code associated with each individual item of personal property which serves as collateral for securing financing by the first source;
receiving financing information from a second financing source, including a unique identification code associated with each individual item of personal property which serves as collateral for securing financing from the source Data regarding the asset the location of asset is collected on the mobile device by a user, and may include dual camera photographs, audio or picture in picture video recordings, text or other types of data comparing the financing information received from the first source with the financing information received from the second source based at least in part upon the identification codes of the items of personal property to determine whether a particular item of personal property simultaneously serves as collateral to secure financing from both the first and second financing sources;
identifying a particular item of personal property which simultaneously serves as collateral to secure financing from both the first and second financing sources, and notifying at least one of the first and second financing sources about the identified item of personal property.
A method for monitoring the status of vehicles which serve as collateral for securing inventory financing of vehicles, the method comprising the steps of:
receiving financing information from a plurality of first financing sources including a unique vehicle identification code associated with each individual vehicle which serves as collateral for securing dealer inventory financing by any of said first financing sources;
receiving financing information from a plurality of second financing sources including a unique vehicle identification code associated with each individual vehicle obtained from dealer inventory which serves as collateral for securing financing from any of said second financing sources;
comparing the received financing information based at least in part upon the vehicle identification codes;
all the units are uploaded by the floorplan company said invention should have the ability to aggregate their information into this software and create a unique identifier for VinVerifEYE in order for the dealer to simply select the Vehicle Identification Number(VIN) number and take pictures identifying vehicles which simultaneously serve as collateral to secure financing from said financing sources; and notifying at least one of the financing sources for which an identified vehicle serves as collateral that the identified vehicle also serves as collateral for another financing source.
